(19) United States
(12) Patent Application Publication
(10) Pub. No.: US 2012/0128059 A1
(43) Pub. Date: May 24, 2012

(54) Method of adaptive motion estimation in search windows for video coding

(75) Inventor: Yueh-Lin Chuang, Hsinchu City (TW)

(73) Assignee: Global Unichip Corporation, Hsinchu City (TW)

(21) Appl. No.: 12/929,242

(22) Filed: Jan. 11, 2011

(30) Foreign Application Priority Data
Nov. 18, 2010 (TW) 099139654

(51) Int. Cl. H04N 7/32

(52) U.S. Cl. 375/240.02; 375/E07.243

(57) ABSTRACT

The invention discloses a method of adaptive motion estimation in search windows for video coding, which uses adjacent MBs to predict the range of search window, storing MVs of adjacent MBs respectively for each reference frame, then using MVs of three adjacent MBs to delimit the scope of search window on the same reference frame. It could derive the most similar MB from the scope of search window than the current MB.

### BACKGROUND OF THE INVENTION

1. Field of the Invention

The invention relates to an adaptive motion estimation method, more particularly to a method of adaptive motion estimation in search windows for video coding.

2. Description of the Prior Art

The market of Multimedia communications currently has a significant growth; particularly the video communication is important and has significant progress in communications technology in view of the cost and the effectiveness. Because of successful development in coding and compression technology, video communications equipment makes a practical improvement and has an important role in IT industry.

Currenttly, in motion vector estimation H.264/AVC proposes the mode of variable block size to increase accuracy of motion vector prediction according to the characteristics of video sequences. However, complexity is relatively high because each mode must be judged. During intra prediction, multiple reference pictures for motion compensation, and mode decision of variable block, the computation time is increaseed. For multiple reference pictures in motion compensation, the traditional coding method just take a picture before the present picture as a reference frame, but the most similar block may exist in multiple previous pictures. Therefore multiple reference frames for improving quality still increase the encoding time in whole process.

Searching the most similar MacroBlock and calculating Summed Absolute Difference (SAD) from reference frame is always a bottleneck on Video decoding. How to improve the search is the most important topic. The traditional method wastes a lot of time on searching the most similar MacroBlock, and calculating Summed Absolute Difference.

FIG. 1 illustrates the original method for searching MVP (Motion Vector Prediction) of current MacroBlock (MB) according to the prior art. The method use Motion Vectors (MVs) of three top MB to estimate MVP. And then these MVs used for searching MVP are computed from the most similar MB of reference frames. For example, the method searches the most similar MB on three reference frames and chooses the MB of the smallest Summed Absolute Difference (SAD). SAD indicates the degree of similar with the current MB. Hence the method derives MV0, MV1 and MV2 from the MB of the smallest SAD. The prior art searches the whole reference frame; it would spend much time on estimating SAD.

The above method to find the similarities in the reference frame blocks needs to search a wide range of blocks, so more time is needed to calculate the absolute sum of difference, while spending a considerable amount of power.

For producing a more efficient video motion estimation in search window, and satisfying the market of multimedia communications, the rapid development of adaptive motion estimation in search windows for video coding is developed in order to enhance the search speed to reduce the search time.

### SUMMARY OF THE INVENTION

The purpose of this invention is to provide an adaptive motion estimation method in search windows for video coding, which reduces the time of windows searching.

The purpose of this invention is to provide an adaptive motion estimation method in search windows for video coding, which utilizes a default search window from Motion Vector Prediction and Motion Vectors stored in the reference frame to calculate the optimal search window for speeding the computation.

The purpose of this invention is to provide an adaptive motion estimation method in search windows for video coding, which uses adjacent MBs to predict the range of search window, and calculates MVs of three adjacent MBs to delimit the scope of search window on the same reference frame. The range of search window is less than or equal to the default search window's, thus the invention can quickly find the position of similar MacroBlock.

To achieved the above-mentioned objective, one embodiment of the present invention provides a method of adaptive motion estimation in search windows for video coding, comprising; selecting a plurality of predetermined MacroBlocks before a current MacroBlock to calculate plurality of relative Motion Vectors for indicating a relative position of the predetermined MacroBlocks corresponding to the current MacroBlock; searching a plurality of reference frames according to the plurality of Motion Vectors and calculating a Motion Vector Prediction for each of the reference frames, then obtaining a plurality of default search windows to each of the reference frames respectively; calculating a plurality of relevant locations for the Motion Vectors with regard to each of the default search windows, and obtaining a plurality of optimal search windows for each of the reference frames respectively; and calculating a Summed Absolute Difference in the optimal search windows for each of the reference frames, then selecting a reference frame with smallest value of Summed Absolute Difference for estimating the current MacroBlock.

Other advantages of the present invention will become apparent from the following description taken in conjunction with the accompanying drawings, which are set forth by way of illustration and example, to certainly embody the present invention.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a diagram illustrating the method for searching MVP of current MB according to the prior art;

FIG. 2 is a flowchart showing a quick search window method of motion pictures according to one embodiment of the present invention;

FIG. 3 is a diagram showing the MacroBlocks for searching MVP of current MacroBlock according to one embodiment of the present;

FIG. 4 is a diagram showing the range of search window in the default search window according to one embodiment of the present invention;

FIG. 5 is a diagram showing the range of search window in the default search window according to another embodiment of the present invention;

FIG. 6 is a diagram showing the range of search window in the default search window according to another embodiment of the present invention; and

FIG. 7 is a flowchart showing a quick search window method of motion pictures according to another embodiment of the present invention.

### DESCRIPTION OF THE PREFERRED EMBODIMENT

The detailed explanation of the present invention is described as following. The described preferred embodiments are presented for purposes of illustrations and description, and they are not intended to limit the scope of the present invention.

The invention discloses a method of adaptive motion estimation in search windows for video coding, which provides a method for quick search and power reduction in motion estimation of video coding.

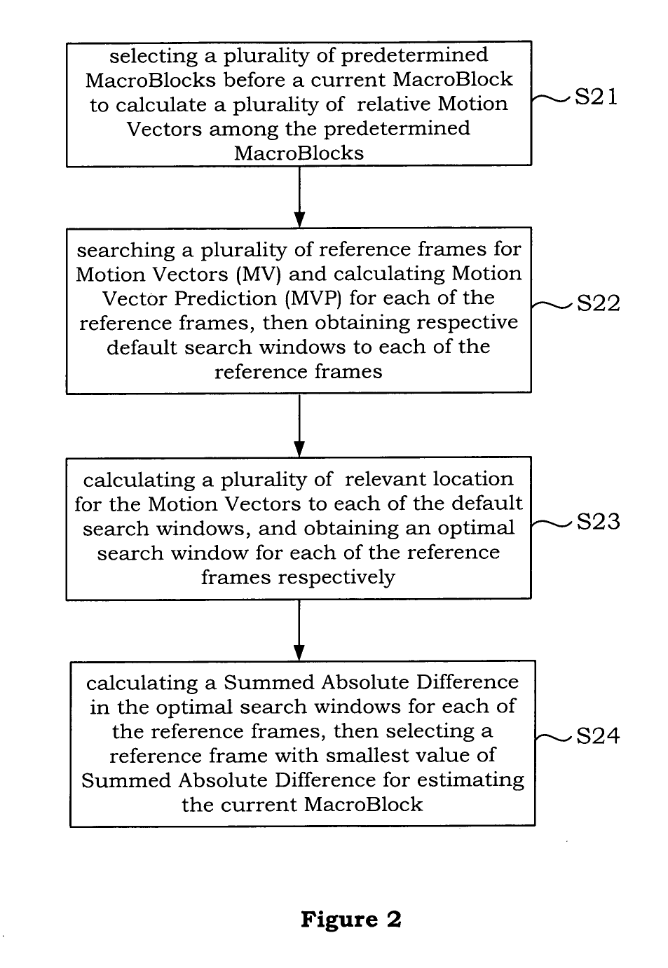

FIG. 2 is a flowchart showing a quick search window method of motion pictures according to one embodiment of the present invention. Step S21 is to select a plurality of predetermined MacroBlocks before current MacroBlock to calculate a plurality of relative Motion Vectors among the predetermined MacroBlocks.

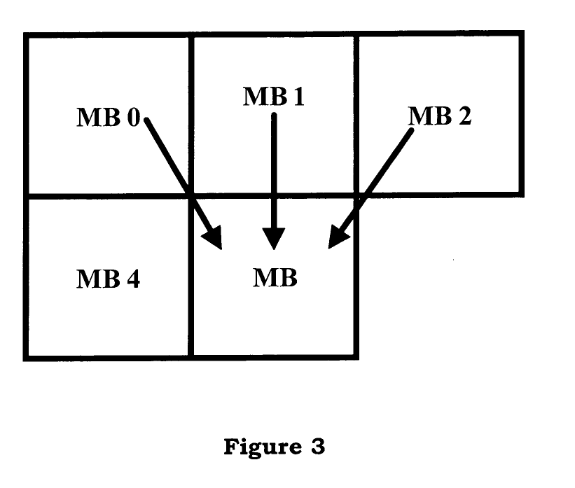

Referring FIG. 3 is a diagram for searching Motion Vector Prediction (MVP) of current MacroBlock according to one embodiment of the present invention. The method use three Motion Vectors (MV0, MV1 and MV2) from the top-left, top-right, and top of current MacroBlock of reference frame 1 to search the Motion Vector Prediction (MVP) of reference frame 1.

As FIG. 2, step S22 searching a plurality of reference frames according to Motion Vectors (MVs) and calculating Motion Vector Prediction (MVP) for each of the reference frames, then obtaining respective default search windows for each of the reference frames.

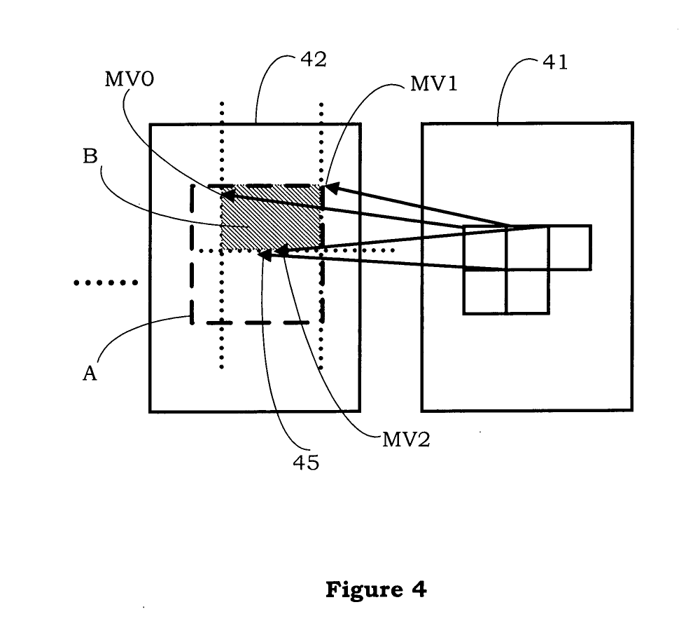

FIG. 4 is a schematic view of motion vectors located in a reference frame according to one embodiment of the present invention. The predetermined MacroBlocks MB0, MB2 and MB1 located on the top-left, top-right, and top of the current MacroBlock in the processing frame 41 are selected for calculating three Motion Vectors MV0, MV1, MV2, which are belonged to previous reference frame 42. The default search window A is the search range of Motion Vector Prediction (MVP) 45. The default search window A is derived from MVP 45 of reference frame 42.

Referring to FIG. 2, step S23 calculating a plurality of relevant locations for the Motion Vectors MV0, MV1 and MV2 to each of the default search windows, and obtaining an optimal search window for each of the reference frames respectively.

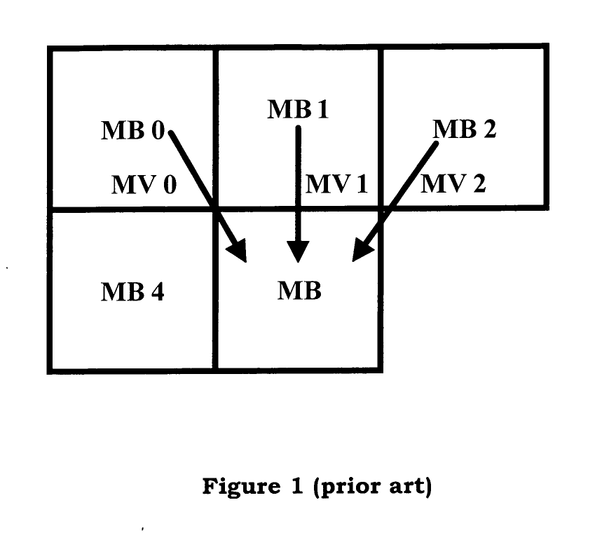

Referring FIG. 4, the window B derived from motion vectors MV0 MV1 MV2 defines a more accurate or smaller search window than the default search window A and the search window B is located in the default search window A. Thus, the optimal search window B is smaller than the default search window A. Referring to FIG. 1, the MacroBlock MB0 is located on the top-left of the MacroBlock MB, thus the MacroBlocks MB0 and MB are kept at the same relevant position when moving. In FIG. 4 the estimated MacroBlock MB at the bottom right of the MacroBlock MB0, thus the range of frame B is in the right of motion vector MV0. Similarly, the MacroBlock MB2 is relative to the location of the top right of the estimated MacroBlock MB, thus the MacroBlock MB2 and the estimated MacroBlock MB remains with the same relative position during displacement. Therefore, in FIG. 4, the estimated MacroBlock MB is located in the relative position of the bottom-left of MacroBlock MB2, so the range of frame B is on the left of motion vector MV2. Accordingly, the invention uses the relation of three adjacent MacroBlocks MB0, MB1, MB2 with motion vectors MV0, MV1, MV2 to delimit the scope of search window on the same reference frame, wherein the frame B is less than the frame A, that the derived window is less than or equal to the default search window. Therefore the invention can quickly find the position of similar MacroBlock and reduce power consumption while saving the time of motion estimation.

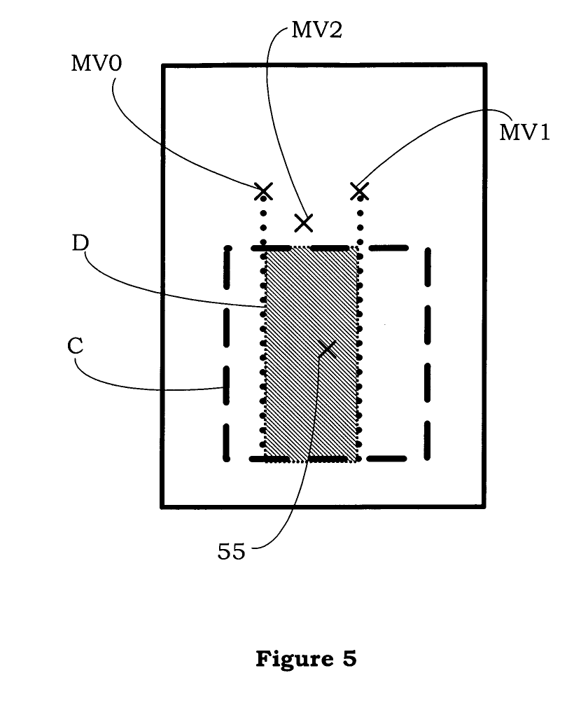

FIG. 5 is the range of search window in the default search window according to another embodiment of the present invention. The default search window C is derived from Motion Vector Prediction (MVP) 55 of reference frame. When the Motion Vectors MV0, MV1, MV2 are outside the default search window C, from the both sides of the Motion Vector MV0, MV1 draw lines to cut the default search window C for the optimal search window D.

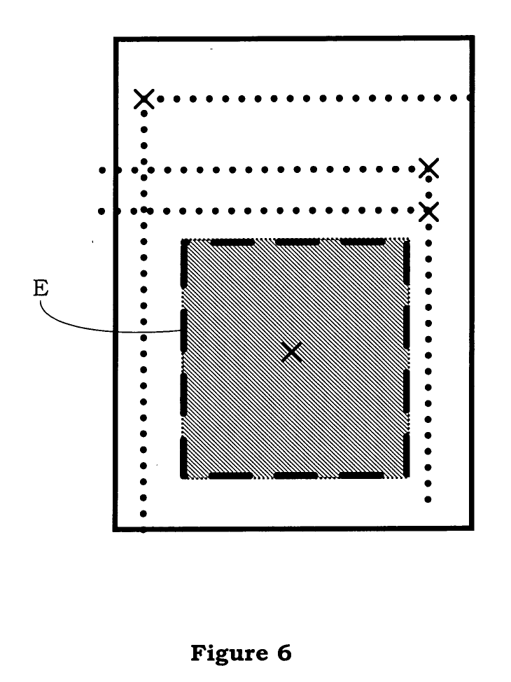

FIG. 6 is the range of search window in the default search window according to another embodiment of the present invention. When the Motion Vectors MV0, MV1, MV2 are outside the default search window E, the default search window E is used for optimal search window.

In FIG. 2, step S24 calculating a Summed Absolute Difference in the optimal search windows for each of the reference frames, and then selecting a reference frame with smallest value of Summed Absolute Difference for estimating the current MacroBlock.

Accordingly, The invention utilizes a default search window from Motion Vector Prediction and Motion Vectors stored in the reference frame to calculate the optimal search window, which is less than or equal to the default search window. It can quickly find the position of similar MacroBlock.

Furthermore, in one embodiment the selected predetermined MacroBlocks may locate on the left, top, and top-right of the forecast MacroBlock.

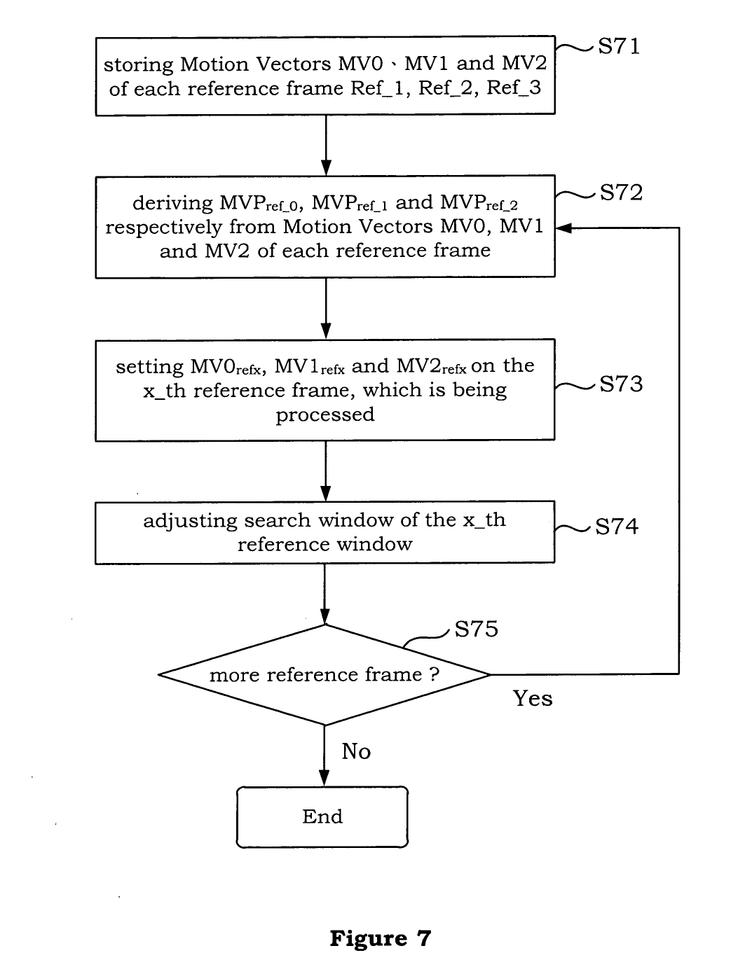

FIG. 7 is a flowchart showing a quick search window method of motion pictures according to another embodiment of the present invention, which including:

Step S71 storing Motion Vectors MV0, MV1 and MV2 of each reference frame Ref_1, Ref_2, Ref_3;

Step 72 deriving MVP_{ref}_{_{—}}₀, MVP_{ref}_{_{—}}₁ and MVP_{ref}_{_{—}}₂ respectively from Motion Vectors MV0, MV1 and MV2 of each reference frame;

Step 73 setting MV0_{refx}, MV1_{refx} and MV2_{refx} on the x_th reference frame, which is being processed;

Step 74 adjusting search window of the x_th reference window; and

Step 75 if there is more reference frame, then continuing with step S72, or go to End.

Accordingly, the invention only uses the stored information to produce optimal search window without additional calculation. It is very economical way to find the target MacroBlock similar to the current MacroBlock. The invention uses Motion Vector Prediction (MVP) to find the default search window and use MV0, MV1 and MV2 of each reference frame to draw novel search window.

It is understood that various other modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which this invention pertains.

What is claimed is:

1. A method of adaptive motion estimation in search windows for video coding, comprising:
selecting a plurality of predetermined MacroBlocks before a current MacroBlock to calculate a plurality of relative Motion Vectors for indicating a relative position of the predetermined MacroBlocks corresponding to the current MacroBlock;
searching a plurality of reference frames according to the plurality of Motion Vectors and calculating a Motion Vector Prediction for each of the reference frames and then obtaining a plurality of default search windows to each of the reference frames respectively;
calculating a plurality of relevant locations for the Motion Vectors with regard to each of the default search windows and obtaining a plurality of optimal search windows for each of the reference frames respectively; and
calculating a Summed Absolute Difference in the optimal search windows for each of the reference frames and then selecting a reference frame with smallest value of Summed Absolute Difference for estimating the current MacroBlock.

2. The adaptive motion estimation method in search windows for video coding according to claim 1, wherein the predetermined MacroBlocks are located on the top-left, top-right, and top of the current MacroBlock respectively.

3. The adaptive motion estimation method in search windows for video coding according to claim 1, wherein MacroBlocks are located on the left, top, and top-right of the current MacroBlock respectively.

4. The adaptive motion estimation method in search windows for video coding according to claim 1, wherein the Motion Vector Prediction is the median value of the Motion Vectors.

5. The adaptive motion estimation method in search windows for video coding according to claim 1, wherein a window derived from the motion vectors is the optimal search window, if the motion vectors are located in the range of the default search window.

6. The adaptive motion estimation method in search windows for video coding according to claim 1, wherein each of the motion vectors cut through the range of the default search window, if any of the motion vectors are located outside of the range of default search window, then the remained area of the default search window is the optimal search window.

7. The adaptive motion estimation method in search windows for video coding according to claim 6, wherein the optimal search window is the default search window if any of the motion vectors are located outside of the range of default search window and the motion vectors cannot cut through the range of default search window.
